(19) United States
(12) Patent Application Publication
(10) Pub. No.: US 2012/0218167 A1
(43) Pub. Date: Aug. 30, 2012

(54) LOW COST PATCH ANTENNA UTILIZED IN WIRELESS LAN APPLICATIONS

(76) Inventors: Ziming He, Irvine, CA (US); Ping Peng, Irvine, CA (US); Oleksandr Gorbachov, Irvine, CA (US)

(21) Appl. No.: 13/335,091

(22) Filed: Dec. 22, 2011

Related U.S. Application Data
(60) Provisional application No. 61/426,286, filed on Dec. 22, 2010.

(51) Int. Cl. H01Q 1/42; H01Q 1/38

(52) U.S. Cl. 343/872

(57) ABSTRACT

The present invention is a low cost patch antenna utilized in one or more wireless LAN applications that include a patch plate that uses double-sided 30 mil FR4 PCB with ½ oz. copper with a cross-shaped slot disposed on the patch plate and a feeding point and a grounding PCB with a top surface. The RF feeding cable has an outer conductor and an inner conductor that is a 50 ohm 086 RF coaxial cable that is used to feed the low cost patch antenna, a plurality of patch supports that include a plurality of plastic cylinders which are used to support the patch plate and a plastic radome to protect the low cost patch antenna. The low cost patch antennas and patch plates can also be assembled in a plurality of different configurations for different Access Points and MIMO applications.

This application claims priority to U.S. Provisional Application 61/426,286 filed on Dec. 22, 2010, the entire disclosure of which is incorporated by reference.

### TECHNICAL FIELD & BACKGROUND

Current Internet access points and routers usually utilize a dipole antenna with a maximum gain of approximately 2 dBi and with a relatively narrow HPBW (half power beam width) in a vertical plane typically in the range of approximately 20° to 30°. Therefore, the dipole antenna's operating range is limited and does not have the capability to cover every corner of a private house or a small business unit for effective Internet access.

When a RF-front-end IC is connected to an access point antenna, it specifically requires that the antenna have a relatively high gain and wide bandwidth and good return loss (i.e. S11 better than −13 dB) so that when the operating point of one or more RFeIC blocks drifts in a certain range, the RFeIC can still work properly. More specifically, when an output matching circuit for power amplifier (PA) and an input matching circuit for a low noise amplifier (LNA), both are connected to the antenna port, the RFeIC blocks are tuned for their optimum performance, typically at approximately 50-Ohm impedance. If an antenna S11 is better than a certain level (i.e. −13 dB), performance degradation of PA and LNA can be negligible, while when S11 is approximately −5 dB (which is typical for most existing embedded antennas at the two ends of an operating frequency band), performance degradation could be relatively very high. In many cases such as cellular phone and other portable applications, since many of a plurality of circuit components are relatively very close to the antenna, and the coupling between the antenna and those components makes the antenna performance to be degraded significantly, and the return loss at the two ends of the operating band is usually approximately −5 dB, the RFeIC's performance will be degraded. Therefore, the system performance of a transceiver will be degraded (i.e., relatively less transmitted power and increased noise figure in receiving mode as well as digital signal quality degradation result in relatively shorter communication link distance and increased time required for particular data file transfer which adversely effects a battery current's consumption etc.)

For antennas that are connected to RF front-end circuitry and are used in WLAN applications, there is generally a plurality of critical requirements. These requirements include relatively wide bandwidth with good return loss (to guarantee the RFeIC working properly under different conditions), relatively high gain, and low cost. A patch antenna is known for its relatively high peak gain, but it has a disadvantage that it usually has a relatively narrow bandwidth. To realize the previously stated requirements, a plurality of techniques can be applied to the patch antenna. To get a low cost patch antenna, only one patch is used in contrast to a plurality of patches utilized to form the patch antenna. Specifically, to get relatively wide bandwidth and good return loss, cross-shaped slots are cut at the center of the patch plate. By adjusting the length of cross-shaped slots on the patch, the coupling between the patch and free space can be controlled, and thus the equivalent patch dimension and impedance can be controlled. Therefore, by adjusting the slot length on the patch and the feeding point location, a relatively low cost, high gain, wide band antenna with excellent return loss can be obtained, and no matching circuitry is needed.

The present invention is a relatively low cost and high performance patch antenna, which has relatively high gain, wide bandwidth, good return loss and high radiation efficiency. The antenna return loss is better than −13 dB across the operating frequency band of 2400-2483.5 MHz, and its bandwidth at S11=−10 dB is approximately 150 MHz. Its maximum gain is approximately +9 dBi and with radiation efficiency greater than 90% in HFSS simulation. For a single patch antenna element, its HPBW (Half Power Beam Width) in a horizontal and elevation plane is approximately in the range of 55 to 70 degrees. Therefore, the antenna's coverage range of an access point device will be relatively greatly increased compared to a conventional dipole antenna. In addition, with a plurality of different embodiments of the antenna, the radiation pattern of the antenna will be improved to approach that of an Omni-directional antenna, and excellent isolation (greater than approximately −32 dB) can be obtained between any two antenna ports, thus the antenna can be used for access point and in MIMO (Multiple-input multiple-output) applications.

The present invention relates to a high performance low cost patch antenna and a plurality of embodiments for WLAN applications. It can be used for any RF-front end circuitry that is utilized in an ISM (Industrial-Scientific-Medical) band. The antenna has a relatively compact size, excellent return loss, wide bandwidth, high gain and high efficiency, and does not require any matching circuitry. Additional embodiments of the antenna are provided to show a plurality of applications of the antenna.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a top perspective view of a low cost patch antenna, in accordance with one embodiment of the present invention.

FIG. 1B illustrates a top view of a low cost patch antenna, in accordance with one embodiment of the present invention.

FIG. 1C illustrates a side view of a low cost patch antenna, in accordance with one embodiment of the present invention.

FIG. 1D illustrates a graph of a simulated return loss of a low cost patch antenna, in accordance with one embodiment of the present invention.

FIG. 1E illustrates a front perspective view of a simulated radiation pattern and peak gain of a patch antenna element, in accordance with one embodiment of the present invention.

FIG. 2A illustrates a side view of a pair of low cost patch antennas, in accordance with one embodiment of the present invention.

FIG. 2B illustrates a front perspective view of a simulated radiation pattern and peak gain of a patch antenna element, in accordance with one embodiment of the present invention.

FIG. 2C illustrates a graph of a simulated return loss from the pair of low cost patch antennas, in accordance with one embodiment of the present invention.

FIG. 3A illustrates a side perspective view of a pair of low cost patch antennas in a back to back configuration, in accordance with one embodiment of the present invention.

FIG. 3B illustrates a front perspective view of a simulated radiation pattern and peak gain of a patch antenna element, in accordance with one embodiment of the present invention.

FIG. 3C illustrates a graph of a return loss and isolation of a back to back antenna configuration, in accordance with one embodiment of the present invention.

FIG. 4A illustrates a side perspective view of a three antenna set in a 120° arrangement, in accordance with one embodiment of the present invention.

FIG. 4B illustrates a front perspective view of a simulated radiation pattern and peak gain of a radiation pattern and peak gain of back to back antenna configuration at 2.45 GHz, in accordance with one embodiment of the present invention.

FIG. 4C illustrates a graph of a return loss and isolation of a return loss and isolation from the three antenna set, in accordance with one embodiment of the present invention.

FIG. 5A illustrates a side perspective view of a four antenna set in a 90° configuration, in accordance with one embodiment of the present invention.

FIG. 5B illustrates a front perspective view of a simulated radiation pattern and peak gain of a radiation pattern and peak gain of 90° four antennas configuration, in accordance with one embodiment of the present invention.

FIG. 5C illustrates a graph of a return and loss isolation of a four antenna set, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

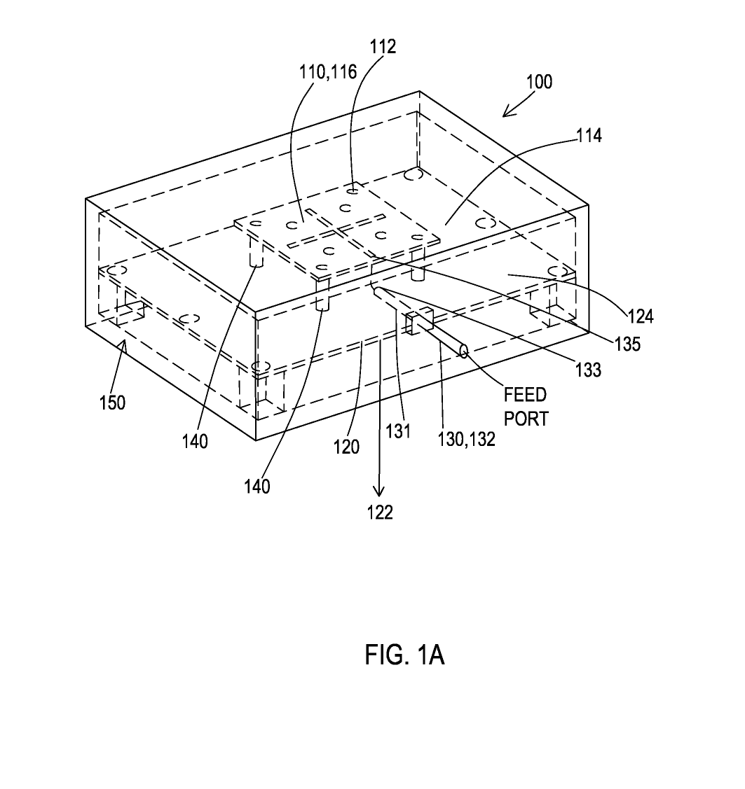

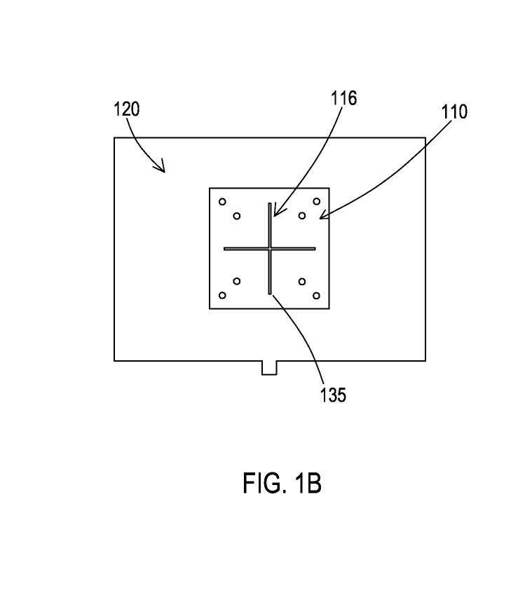

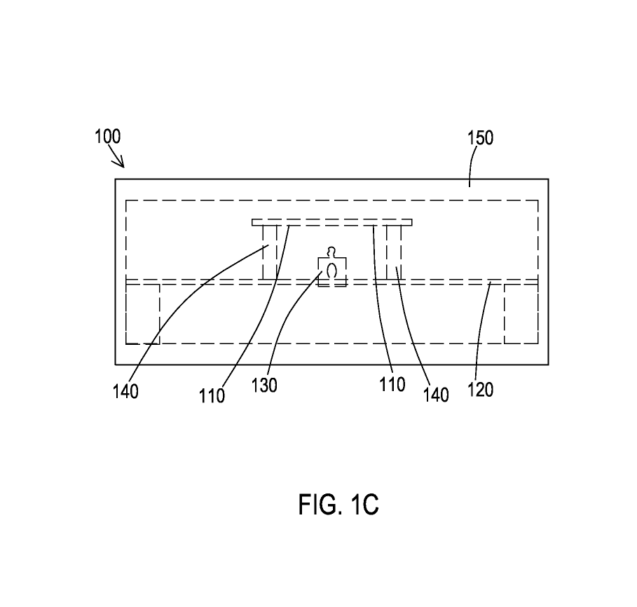

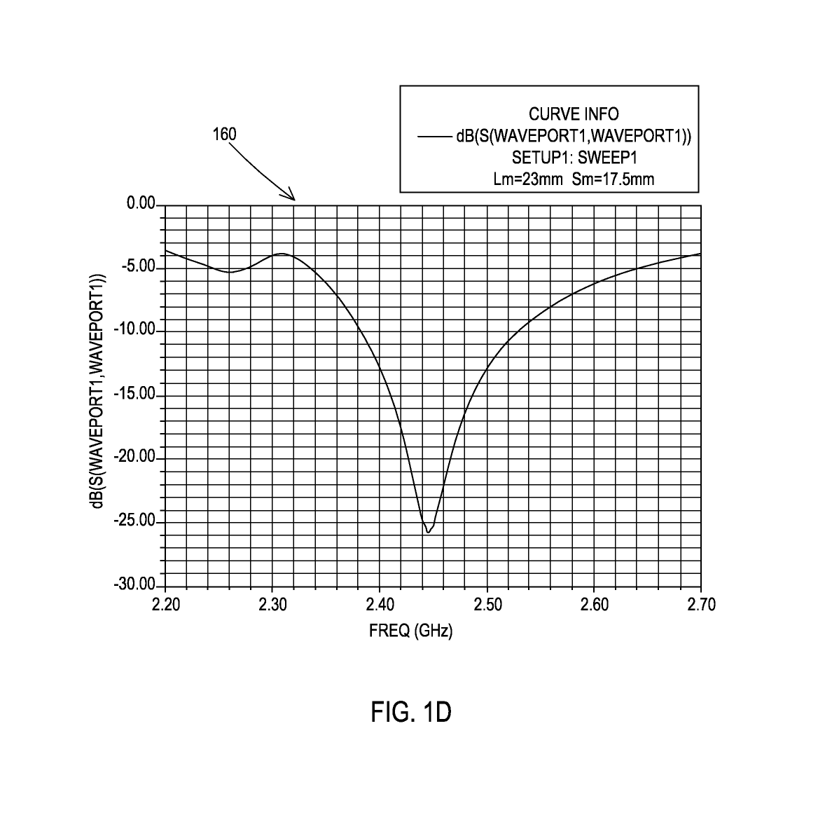

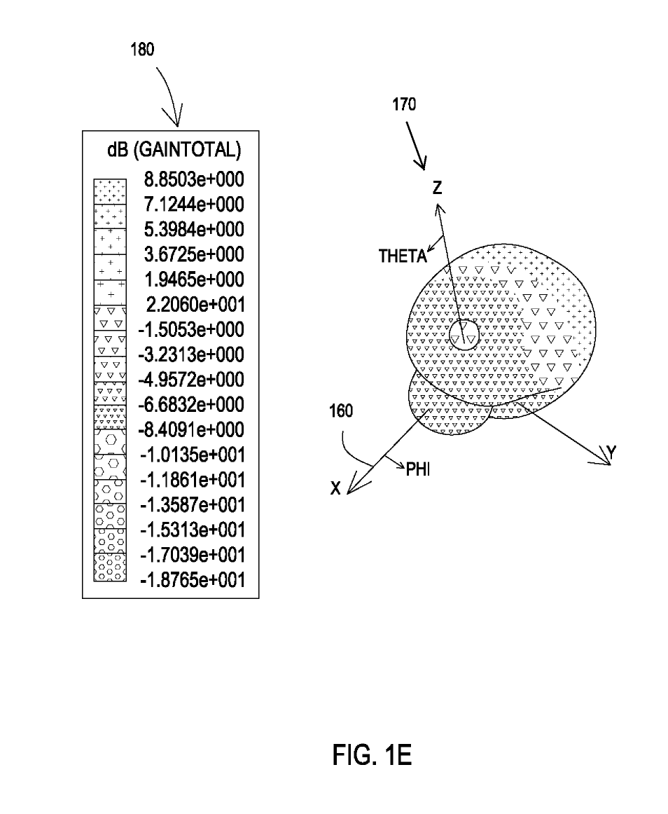

FIG. 1A illustrates a top perspective view of a low cost patch antenna 100, in accordance with one embodiment of the present invention. FIG. 1B has similar elements as the elements described and illustrated in Figure A.

The low cost patch antenna 100 includes a patch plate 110, a grounding PCB 120, a RF feeding cable 130, a plurality of patch supports 140 and a plastic radome 150.

The low cost patch antenna 100 is a low cost high performance 2.45 GHz ISM band patch antenna utilized in WLAN applications, especially one or more access point applications and MIMO applications. The low cost patch antenna 100 has only one patch plate 110 with a cross-shaped slot 112 disposed on the patch plate 110. The patch plate 110 is made of PCB, metal or other suitable material with a total thickness of approximately 0.8 mm, and the dielectric 114 between the patch plate 110 and the grounding PCB 120 is air. Both the patch plate 110 and grounding PCB 120 use double-sided 30 mil FR4 PCB with ½ oz. copper 116,122. The RF feeding cable 130 is a 50 ohm 086 RF coaxial cable 132 that is used to feed the low cost patch antenna 100. The outer conductor 131 of the 086 RF coaxial cable 132 is soldered on the top surface 124 of the grounding PCB 120, and the inner conductor 133 is soldered on a soldering point 135 on patch plate 110. The plurality of patch supports 140 are made of Teflon plastic but can be made of any other suitable plastic material. The plastic radome 150 is made of PVC plastic with a dielectric constant of 2.6. The dimensions of the plastic radome 150 are approximately 126 mm in length, 92 mm in width and 27.4 mm in height with a thickness of 3 mm. The radome 150 can be made of any other suitable plastic material too. The low cost patch antenna 100 is connected to an RF front-end chipset with 50 ohm RF coaxial cable 132, and no additional matching circuitry is required for its operation.

FIG. 1B illustrates a top view of a low cost patch antenna 100, in accordance with one embodiment of the present invention. FIG. 1B has similar elements as the elements described and illustrated in FIG. 1A. The low cost patch antenna 100 is fed with a 086 RF coaxial cable 132. The outer conductor 131 of the 086 RF coaxial cable 132 is soldered on the grounding PCB top surface 124, and the inner conductor 133 of the 086 RF coaxial cable 132 is soldered on the patch plate 110. The soldering point 135 is approximately 4.5 mm from the edge 116 of the patch plate 110. The patch supports 140 are a plurality of plastic cylinders 142 with a diameter of approximately 2 mm which are used to support the patch plate 110. The plastic cylinders 142 are made of Teflon plastic, but other plastic or other suitable materials can be used too. The distance between the patch plate 110 top surface 118 to the plastic Radome 150 inner wall 152 is approximately 3 mm. The thickness of the plastic Radome 150 is approximately 3 mm.

FIG. 1C illustrates a side view of a low cost patch antenna 100, in accordance with one embodiment of the present invention. FIG. 1C has similar elements as the elements described and illustrated in Figure A and Figure B. The low cost patch antenna 100 has a relatively compact size, high gain, high efficiency, wide bandwidth and excellent return loss, resulting in a low cost and high performance patch antenna element. Due to wide bandwidth and excellent return loss, high gain and high efficiency, the patch antenna element will have a plurality of extensive applications in a plurality of WLAN applications.

### HFSS Simulation Results:

The low cost and high performance patch antenna element 100 for 2.4 GHz ISM band (2.4-2.4835 GHz) was designed with HFSS software. The antenna dimensions have been optimized until excellent performance (Return loss, bandwidth, peak gain etc.) has been obtained in HFSS simulation. The patch plate 110 and grounding PCB 120 use double-sided 30 mil FR4 PCB with ½ oz. copper 116,122, as previously illustrated in FIG. 1B and FIG. 1C. The plastic radome 150 uses 3 mm thickness PVC material, although other suitable plastic materials can also be utilized.

FIG. 1D illustrates a graph 160 of a simulated return loss of a low cost patch antenna, in accordance with one embodiment of the present invention. The return loss is −12.8 dBi at 2.4 GHz and −14.5 dBi at 2.49 GHz.

FIG. 1E illustrates a front perspective view of a simulated radiation pattern 170 and peak gain of a patch antenna element 100, in accordance with one embodiment of the present invention.

From FIG. 1E it is seen that the maximum radiation direction is along the x-axis direction of the graph 160 as illustrated in FIG. 1D. In XZ plane (Phi=0 degree) the simulated HPBW is approximately 55 degrees and in XY plane (Theta=90 degrees) the simulated HPBW is approximately 70 degrees. A scale 180 is provided that indicates a predetermined dB gain range total based on the plurality of colors illustrated on the simulated radiation pattern 170.

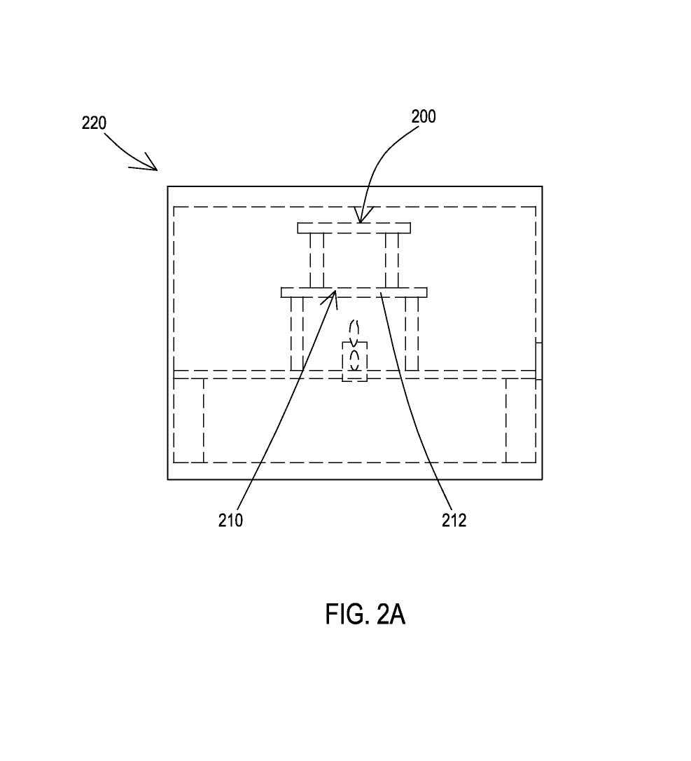

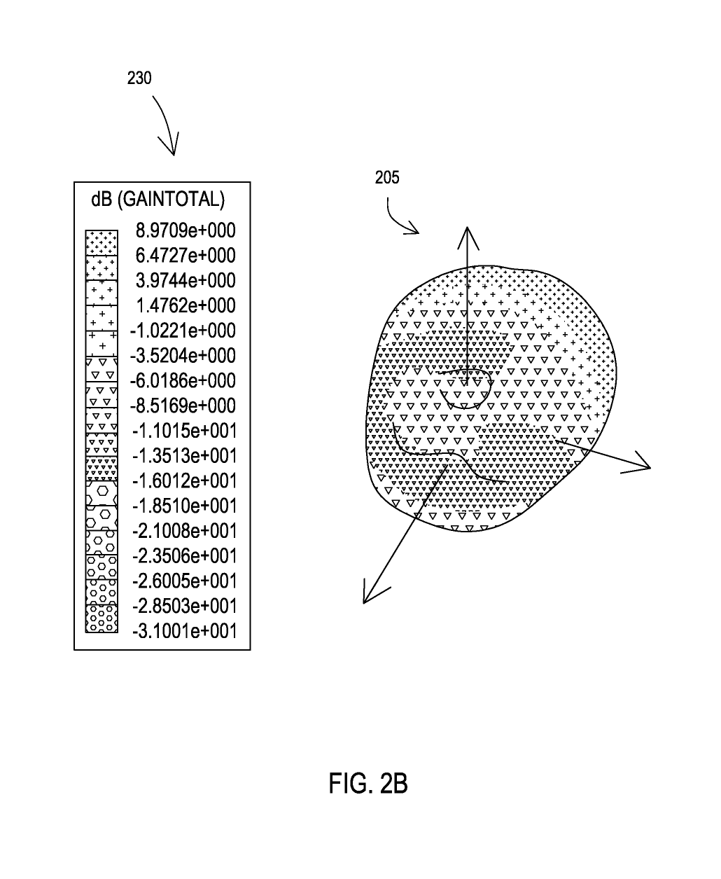

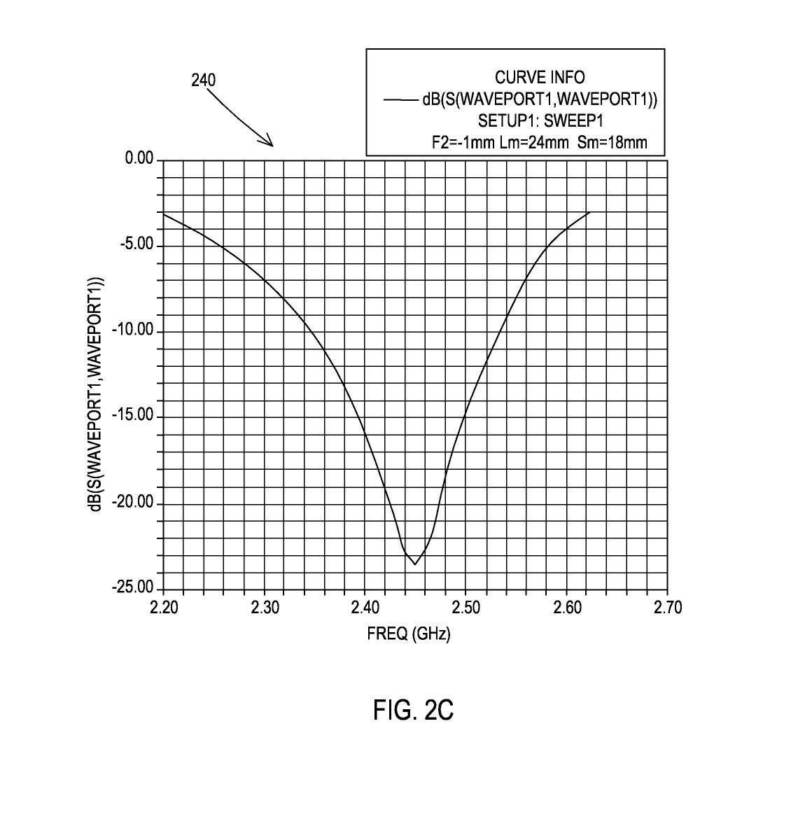

FIG. 2A illustrates a side view of a pair of low cost patch antennas 200,210, in accordance with one embodiment of the present invention. The upper patch 200 is stacked horizontally above the lower patch 210 forming a horizontal configuration 220. The dimensions of the lower patch 210 are 48 mm×48 mm×0.8 mm, and the dimensions of the upper patch 200 are 37 mm×37 mm×0.8 mm. The lower patch 210 has a plurality of slots 212 disposed on it, but the upper patch 200 does not have any slots. The distance between upper patch 200 and lower patch 210 is 6 mm.

FIG. 2B illustrates the simulated radiation pattern 205 and peak gain of the pair of low cost patch antennas 200,210. FIG. 2B has similar elements as the elements described and illustrated in FIG. 2A. The peak gain at 2.45 GHz is +8.97 dBi. The peak directivity at 2.45 dGz is +9.00 dBi and the radiation efficiency is 99.3% in HFSS simulation. A scale 230 is provided that indicates a predetermined dB gain range total based on the plurality of colors illustrated on the simulated radiation pattern 205.

FIG. 2C illustrates a graph 240 of a simulated return loss from the pair of low cost patch antennas, in accordance with one embodiment of the present invention. FIG. 2C shows the simulated return loss from the pair of low cost patch antennas 200,210. The return loss is −15.7 dB at 2.4 GHz and −16.7 dB at 0.49 GHz. The simulated radiation pattern and peak gain is shown in FIG. 2A. The peak gain of the low cost patch antenna 100 at 2.45 GHz is +8.85 dBi. The peak directivity is +9.03 dBi at 2.45 GHz and the radiation efficiency at 2.45 GHz is 96.02% in HFSS simulation.

From FIG. 1D and FIG. 2C it is shown that when the upper patch 200 is horizontally stacked on the lower patch 210, the antenna performance is improved. The bandwidth of the pair of low cost patch antennas 200,210 will be improved significantly when the upper patch 200 is added above the lower patch 210.

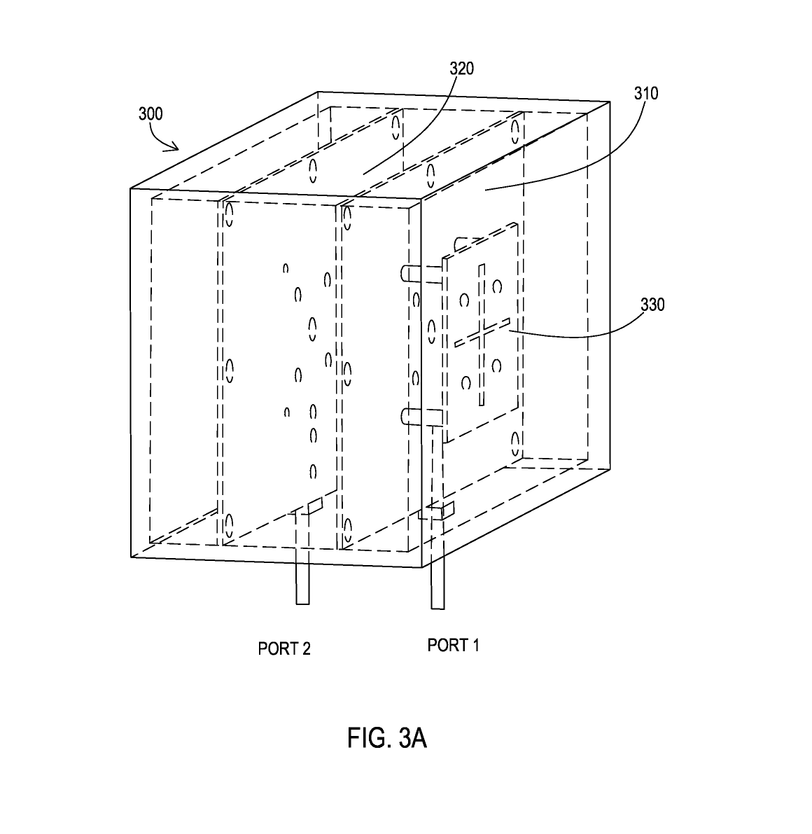

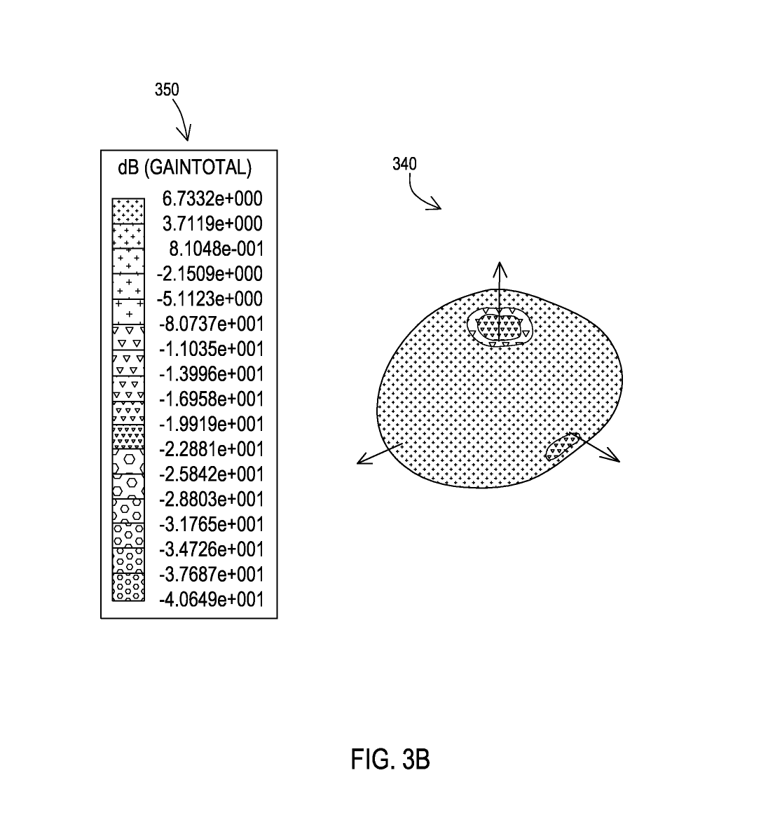

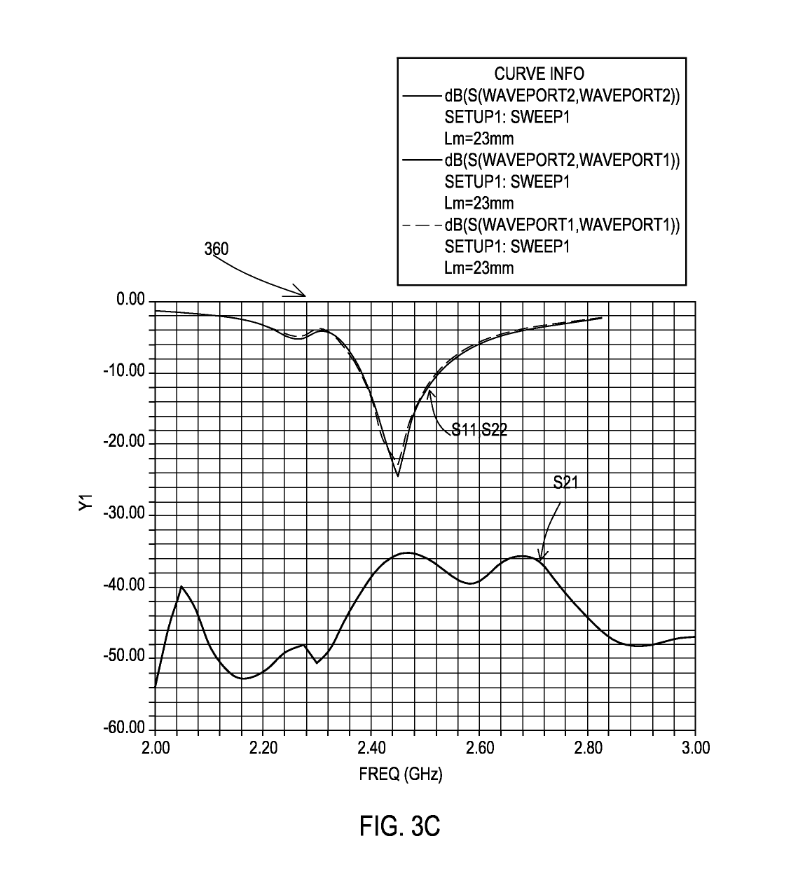

FIG. 3A illustrates a side perspective view of two antenna sets 300 in a 180° arrangement (back-to-back configuration) for 2×2 MIMO application, in accordance with one embodiment of the present invention. The two antenna sets 300 are low cost patch antenna sets previously illustrated and described in FIGS. 1A-1C and include a first antenna set 310 and a second antenna set 320.

FIG. 3B illustrates a front perspective view of a simulated radiation pattern 340 and peak gain of two antenna sets 300 in a 180° arrangement (back-to-back configuration) for 2×2 MIMO application 330, in accordance with one embodiment of the present invention.

When two patch antennas are fed equally, the radiation pattern of the third embodiment 300 is shown in FIG. 3B. When only one patch antenna of 310, 320 is fed (or the two patch antennas are fed independently), the peak gain at 2.45 GHz is +8.85 dBi. When both low cost patch antennas are fed equally with a power splitter (not shown), the combined low cost patch antenna 300 has two maximum radiation directions, thus the peak gain at 2.45 GHz is reduced to +6.73 dBi since radiated energy is distributed between the two maximum radiations, but the radiation pattern is improved that is good for an access point application. Because of the superb isolation between both low cost patch antennas, the back to back configuration 300 can be suitably used in 2×2 MIMO (Multiple-input and multiple-output) applications as well. A scale 350 is provided that indicates a predetermined dB gain range total based on the plurality of colors illustrated on the simulated radiation pattern 340.

FIG. 3C illustrates a graph 360 of a return loss and isolation of a back to back antenna configuration, in accordance with one embodiment of the present invention.

The simulated return loss and isolation between the two low cost patch antennas 310 and 320 are shown in FIG. 3C. By adjusting the slot 330 length of the patch, the patch antennas 310,320 illustrate a relatively wider bandwidth. The return loss is better than −13 dB in FIG. 3C. The isolation between the two patch antennas 310 and 320 is greater than −35 dB.

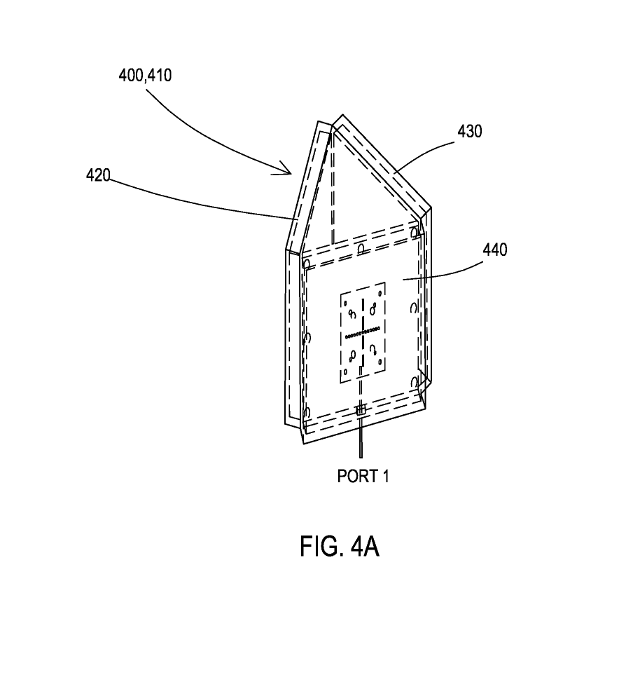

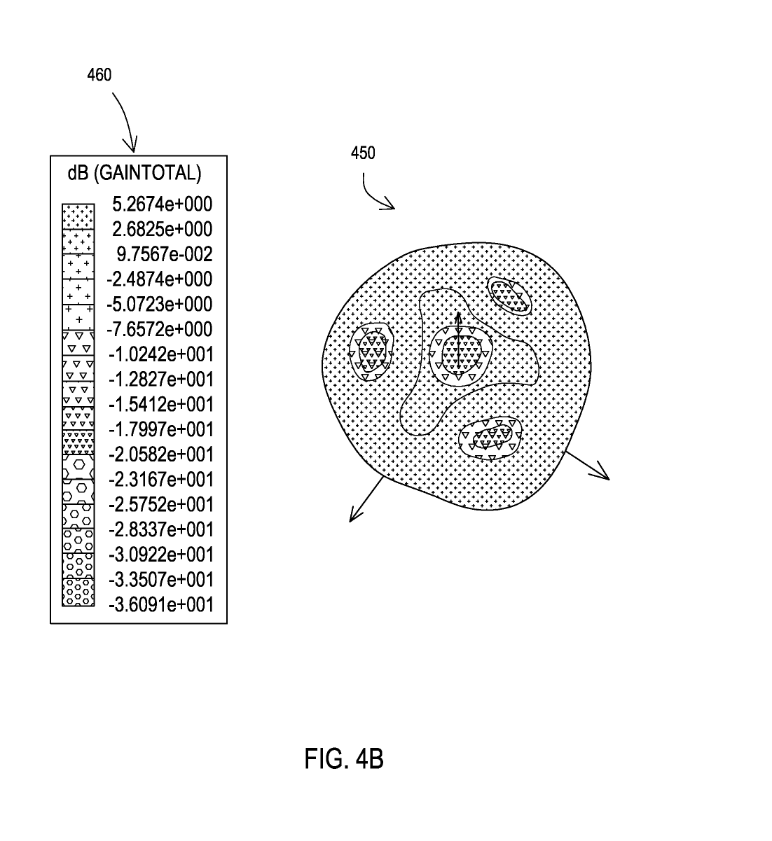

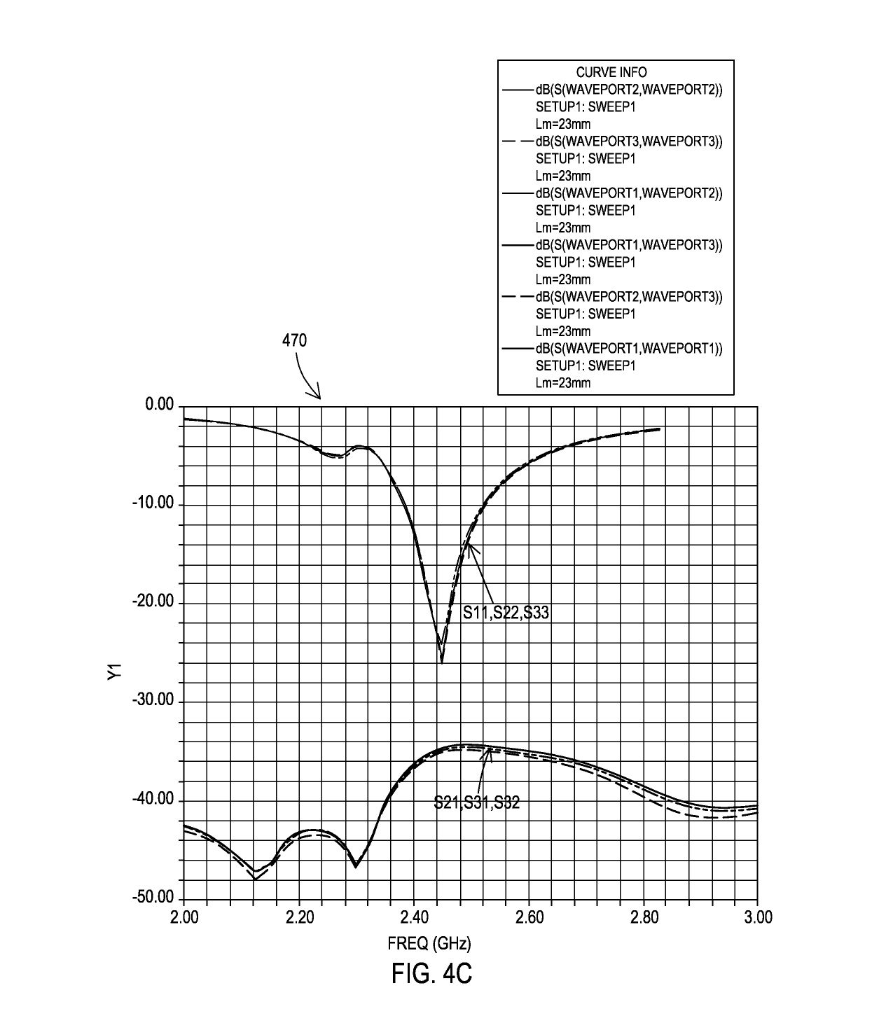

FIG. 4A illustrates a side perspective view of three antenna sets 400 in a 120° arrangement 410, in accordance with one embodiment of the present invention. The three antenna sets 400 are low cost patch antenna sets previously illustrated and described in FIGS. 1A-1C and include a first antenna set 420, a second antenna set 430 and a third antenna set 440. The simulated return loss and isolation between any antenna sets 420,430,440 are shown in Graph 7. The return loss is better than −13 dB, and the isolation between any two antenna sets 420,430,440 is better than −34 dB.

FIG. 4B illustrates a front perspective view of a simulated radiation pattern 450 and peak gain of a radiation pattern and peak gain of 120° configuration 400 at 2.45 GHz, in accordance with one embodiment of the present invention. When the three patch antennas are fed equally, the radiation pattern of the three antenna sets 410 is illustrated in FIG. 4B.

When all three antenna sets 420,430,440 are fed equally with a power splitter (not shown), the antenna arrangement 410 has three maximum radiation directions, thus the peak gain is reduced to +5.27 dBi since radiated energy is distributed among three maximum radiations, but the radiation pattern is improved significantly that is suitable for access point applications. Because of the superb isolation between any two antenna sets 420,430,440, this antenna arrangement 410 can be suitably used in 3×3 MIMO applications. A scale 460 is provided that indicates a predetermined dB gain range total based on the plurality of colors illustrated on the simulated radiation pattern 450.

FIG. 4C illustrates a graph 470 of a return loss and isolation of a return loss and isolation from the three antenna set, in accordance with one embodiment of the present invention. When only one antenna set 420,430,340 is fed (or three antennas sets 420,430,440 are fed independently), the peak gain is +8.85 dBi.

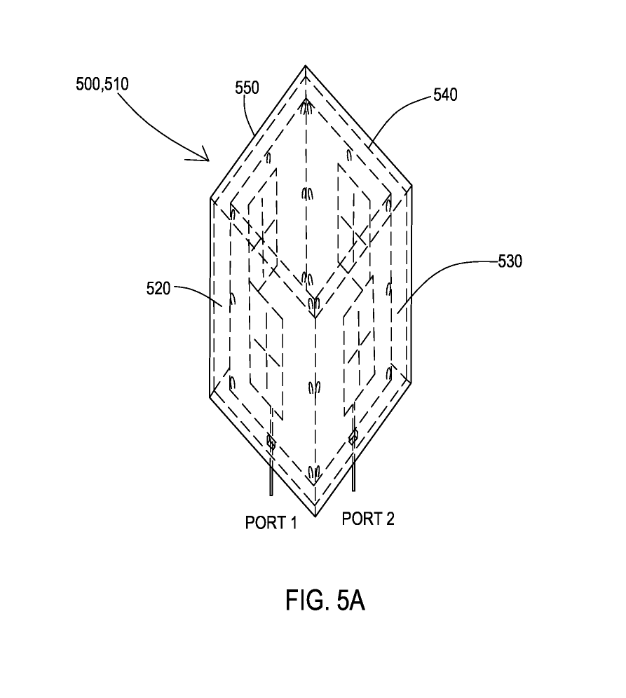

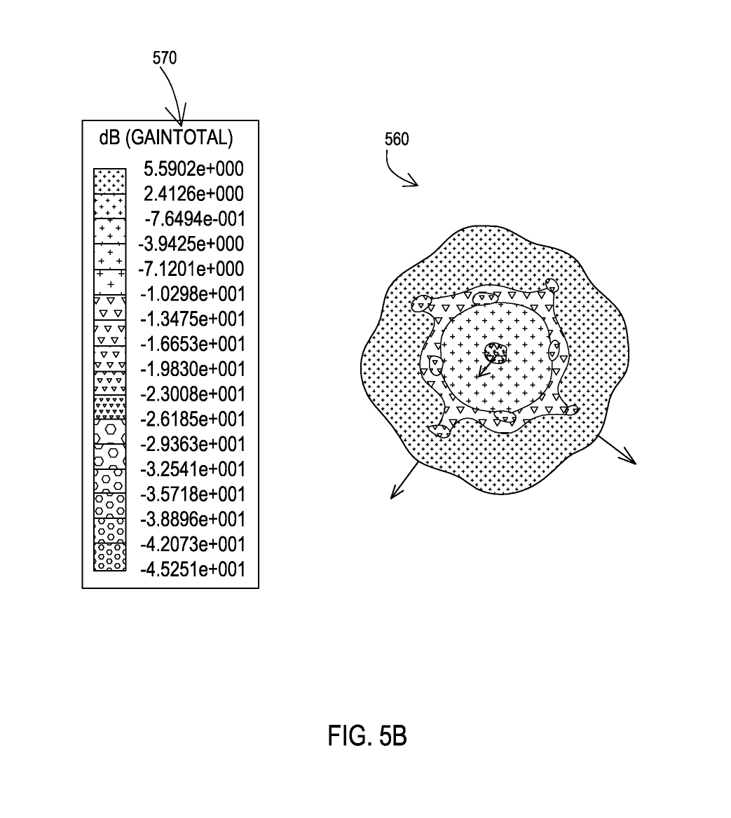

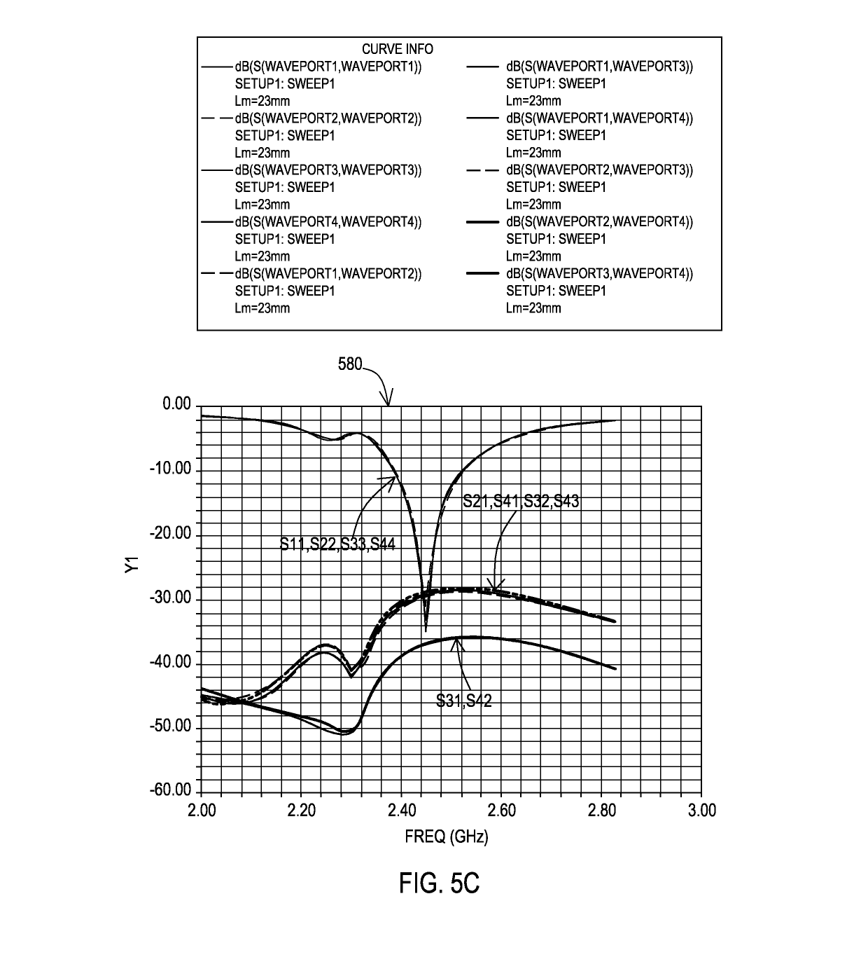

FIG. 5A illustrates a side perspective view of four antenna sets 500 in a 90° configuration 510, in accordance with one embodiment of the present invention.

The four antenna sets 500 include a first antenna set 520, a second antenna set 530, a third antenna set 540 and a fourth antenna set 550. The return loss and isolation between any two antenna sets 520,530,540,550 are shown in FIG. 4C. The return loss is greater than approximately −12 dB across a range of a 2.4-2.5 GHz frequency band, and the isolation between any two antenna sets 520,530,540,550 is better than approximately −28 dB.

FIG. 5B illustrates a front perspective view of a simulated radiation pattern 560 and peak gain of a radiation pattern and peak gain of 90° four antennas configuration, in accordance with one embodiment of the present invention.

When all four antennas are fed equally, the radiation pattern of the four antenna sets is shown in FIG. 5B. Because of the superb isolation between any two antenna sets 520,530,540,550, this antenna configuration 510 can be used in 4×4 MIMO (Multiple-input and multiple-output) applications as well as 5××5 MIMO applications. One additional low cost patch antenna can also be disposed on top of this antenna configuration 510 to form a 5×5 MIMO application. A scale 570 is provided that indicates a predetermined dB gain range total based on the plurality of colors illustrated on the simulated radiation pattern 560.

FIG. 5C illustrates a graph 570 of a return and loss isolation of a four antenna set, in accordance with one embodiment of the present invention. When only one antenna set 520,530,540,550 is fed (or four antennas 520,530,540,550 are fed independently), the peak gain is +8.85 dBi. When all four antennas 520,530,540,550 are fed equally with a power splitter (not shown), the antenna configuration 510 has four maximum radiation directions, thus the peak gain is reduced to +5.6 dBi since radiated energy is distributed among four maximum radiations, but the radiation pattern is improved significantly and is now very close to that of an Omni-directional antenna, and that is suitable for access point applications.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A low cost patch antenna utilized in one or more wireless LAN applications, comprising:
a patch plate that uses double-sided 30 mil FR4 PCB with ½ oz. copper with a cross-shaped slot disposed on said patch plate and a feeding point;
a grounding PCB with a top surface;
a RF feeding cable with an outer conductor and an inner conductor that is a 50 ohm 086 RF coaxial cable that is used to feed said low cost patch antenna;
a plurality of patch supports that include a plurality of plastic cylinders which are used to support said patch plate; and
a plastic radome to protect said low cost patch antenna.

2. The antenna according to claim 1, wherein said cross-shaped slot length can be adjusted to increase bandwidth.

3. The antenna according to claim 1, wherein said patch plate is made of PCB or metal.

4. The antenna according to claim 1, wherein said patch plate has a total thickness of approximately 0.8 mm.

5. The antenna according to claim 1, wherein said feeding point is approximately 4.5 mm from an edge of said patch plate.

6. The antenna according to claim 1, wherein an upper patch plate is stacked horizontally above a lower patch plate forming a horizontal configuration.

7. The antenna according to claim 1, wherein a pair of said low cost patch antennas are in a vertical back-to-back configuration.

8. The antenna according to claim 1, wherein said grounding PCB uses double-sided 30 mil FR4 PCB with ½ oz. copper.

9. The antenna according to claim 1, wherein said outer conductor is soldered on said top surface of said grounding PCB.

10. The antenna according to claim 1, wherein said inner conductor is soldered on said feeding point on said patch plate.

11. The antenna according to claim 1, wherein said plastic cylinders are made of Teflon plastic.

12. The antenna according to claim 1, wherein said patch supports have a diameter of approximately 2 mm.

13. The antenna according to claim 1, wherein said plastic radome dimensions are approximately 126 mm in length, 92 mm in width and 27.4 mm in height with a thickness of approximately 3 mm.

14. The antenna according to claim 1, wherein said plastic radome is made of PVC plastic with a dielectric constant of approximately 2.6.

15. The antenna according to claim 1, wherein said low cost patch antenna is a low cost high performance 2.4 GHz ISM band patch antenna utilized in said WLAN applications.

16. The antenna according to claim 1, wherein said low cost patch antenna is utilized in one or more access point applications or utilized in one or more MIMO applications.

17. The antenna according to claim 1, wherein said low cost patch antenna is connected to an RF front-end chipset with said 50 ohm RF coaxial cable.

18. The antenna according to claim 1, wherein three said low cost patch antenna set are set in a 120° arrangement.

19. The antenna according to claim 1, wherein four said low cost patch antenna sets are set in a 90° arrangement.

20. The antenna according to claim 19, wherein one additional said low cost patch antenna is disposed on top of said four low cost patch antenna sets to form a 5×5 MIMO application.
